(19) United States
(12) Patent Application Publication
(10) Pub. No.: US 2020/0070584 A1
(43) Pub. Date: Mar. 5, 2020

(54) TIRE FOR A VEHICLE

(71) Applicant: COMPAGNIE GENERALE DES ETABLISSEMENTS MICHELIN, Clermont-Ferrand (FR)

(72) Inventors: FRANCOIS HOTTEBART, Clermont-Ferrand (FR); JEAN-CHARLES DEROBERT-MAZURE, Clermont-Ferrand (FR); GUILLAUME ANDRE, Clermont-Ferrand (FR); ANTOINE MAUGER, Clermont-Ferrand (FR); EVE-ANNE FILIOL, Clermont-Ferrand (FR)

(21) Appl. No.: 16/610,763

(22) PCT Filed: Apr. 25, 2018
(86) PCT No.: PCT/FR2018/051041

§ 371 Date: Nov. 4, 2019

(30) Foreign Application Priority Data
May 5, 2017 (FR) 1753980

(51) Int. Cl. B60C 9/00; B60C 9/18; B60C 9/20

(52) U.S. Cl. CPC B60C 9/0064; B60C 9/0007; B60C 9/0042; B60C 9/1807; B60C 2009/2093; B60C 2009/0085; B60C 2009/2016; B60C 2009/2019; B60C 2009/209; B60C 9/2003

(57) ABSTRACT

Breaking energy test performance of lightweight tyres that have a good performance in terms of rolling resistance is increased. These tyres comprise two thin and lightened working layers (41, 42) comprising metal reinforcing elements (411, 421) having a linear breaking strength Rct at most equal to 400 daN/cm, and a single carcass layer (6) radially on the inside of the working layers. In order to successfully undergo the “breaking energy” test, this carcass layer comprises textile reinforcing elements that have an elongation at break Acc at least equal to 15%, the carcass layer having a linear breaking strength Rcc at least equal to 0.55 times the linear breaking strength of the working layers.

### FIELD OF THE INVENTION

The present invention relates to a passenger vehicle tyre, and more particularly to the crown of such a tyre.

Since a tyre has a geometry that exhibits symmetry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively.

In the following text, the expressions “radially on the inside of” and “radially on the outside of” mean “closer to the axis of rotation of the tyre, in the radial direction, than” and “further away from the axis of rotation of the tyre, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tyre and an “axial distance” is a distance with respect to the equatorial plane of the tyre. A “radial thickness” is measured in the radial direction and an “axial width” is measured in the axial direction.

A tyre comprises a crown comprising a tread that is intended to come into contact with the ground via a tread surface, two beads that are intended to come into contact with a rim, and two sidewalls that connect the crown to the beads. Furthermore, a tyre comprises a carcass reinforcement, comprising at least one carcass layer that is radially on the inside of the crown and connects the two beads.

The tread is also made up of one or more rubber compounds. The expression “rubber compound” denotes a composition of rubber comprising at least an elastomer and a filler.

The crown comprises at least one crown reinforcement radially on the inside of the tread. The crown reinforcement comprises at least one working reinforcement comprising at least one working layer made up of mutually parallel reinforcing elements that form, with the circumferential direction, an angle of between 15° and 50°. The crown reinforcement may also comprise a hoop reinforcement comprising at least one hooping layer made up of reinforcing elements that form, with the circumferential direction, an angle of between 0° and 10°, the hoop reinforcement usually, but not necessarily, being radially on the outside of the working layers.

### PRIOR ART

In the current context of sustainable development, the saving of resources and therefore of raw materials is one of the industry's key objectives. For passenger vehicle tyres, one of the avenues of research for this objective consists in reducing the mass and thus the breaking strength of the metal cords usually used as reinforcing elements for the different layers of the crown reinforcement. This approach can lead to the replacement of these metal cords with individual threads or monofilaments as described in the document EP 0043563, in which this type of reinforcing elements is used with the twofold objective of saving on mass and lowering rolling resistance.

Similarly, the architectures of tyres in which the carcass reinforcement is made up of a single carcass layer are more advantageous from a point of view of saving material than the architectures in which the carcass reinforcement has at least two carcass layers.

Thus, the savings of raw materials result in tyres being designed in which the working layers having an increasingly low breaking strength. This modification of the crown layers does not in principle require any modification of the carcass layer for one and the same size and one and the same pressure.

However, the use of this type of reinforcing elements in the crown layers has the drawback of lowering the resistance of the crown to puncturing by certain objects. Thus, regulations exist, notably American (ASTM WK20631) and Chinese (GB 9743-2007) regulations, which are based on the measurement of the energy necessary for an indenter to penetrate the crown of the tyres. The lowering of the resistance to puncturing caused by the use of these reinforcing elements in a tyre has the consequence that these tyres no longer comply with these regulations. These tyres thus become unfit for sale in these countries, and for import both as detached parts and in a state mounted on vehicles. Compliance with the regulations is consequently a significant commercial issue for all manufacturers, whether or not they manufacture in these countries.

These penetration tests are commonly known as “breaking energy tests”. The breaking energy of the tyre under the test conditions imposed by the regulations is thus referred to as “breaking energy performance”. The tests and the associated performance will be referred to in this way in the rest of the document. For tyres of the same type, that is to say from the same factory, with the same architecture, and with the same tread, the results are spread by close to 10%, such that the intended performance for a tyre when it is designed is the value prescribed by the regulations plus 10%.

For this type of performance, the breaking strength of the reinforcing elements of the working layers is considered to be instrumental, as shown by the U.S. Pat. No. 8,662,128, via the reinforcement thereof either by increasing the density, or by increasing the diameter of the elementary threads of the reinforcing elements of the working layers. However, these solutions run counter to the primary objective of the inventors, which is to save on mass and raw materials. The reinforcing elements of the at least one carcass layer are dimensioned usually in accordance with the burst pressure of the tyre.

### SUMMARY OF THE INVENTION

The main objective of the present invention is therefore to increase the performance in terms of resistance to penetration of a tyre of which the reinforcing elements of the working layers have a low mass, so as to satisfy the breaking energy tests and to improve the rolling resistance thereof.

This objective is achieved by a vehicle tyre comprising:
a tread,
a crown reinforcement radially on the inside of the tread and comprising at least one working reinforcement,
the working reinforcement comprising at least two working layers, each working layer having a linear breaking strength Rct, each working layer comprising metal reinforcing elements,
the metal reinforcing elements of the working layers comprising individual metal threads or monofilaments,
a single carcass layer that is radially on the inside of the crown reinforcement and connects together two beads that are intended to come into contact with a rim and comprise textile reinforcing elements, the carcass layer having a linear breaking strength Rcc,
the linear breaking strength Rct of each working layer is at least equal to 300 daN/cm and at most equal to 400 daN/cm,
the elongation at break Acc of the textile reinforcing elements of the carcass layer is at least equal to 15%,
if the tyre has a nominal width at least equal to 135 mm, preferably at least equal to 185 mm and at most equal to 235 mm, the linear breaking strength Rcc of the carcass layer is at least equal to 0.55 times the linear breaking strength Rct of the working layers, and if the tyre has a nominal width at least equal to 245 mm, the linear breaking strength Rcc of the carcass layer is at least equal to 0.65 times the linear breaking strength Rct of the working layers.

The tyres of which the working layers have linear breaking strengths at most equal to 400 daN/cm, preferably at most equal to 350 daN/cm, cannot satisfy the breaking energy regulations without adaptation of the crown. Given the objective of the invention, it is not conceivable to increase the linear breaking strength of the working layers via the density and the diameter of the reinforcing elements thereof. Furthermore, increasing the density of the reinforcing elements in fact decreases the thickness of rubber compound between two adjacent reinforcing elements without decreasing the deformations in shear thereof. This increases the risk of the rubber compounds of the working layers cracking.

The linear breaking strength of a layer Rc is defined by Rc=Fr*d, where Fr is the tensile breaking force of the reinforcing elements of the layer in question, and d is the density of the reinforcing elements of the layer in question, measured around the radially outermost point of each layer.

In order to respect the other performance aspects of the tyre, it is necessary for the working layers to have linear breaking strengths at least equal to 300 daN/cm.

According to the usual design rules of the prior art for performance in the breaking energy test, the crown of the tyre deforms around the head of the indenter and is mainly subjected to bending. According to these rules, given the respective positions of the working layers which are closer to the indenter applied to the tread, and of the carcass layer, the bending stresses are higher in the carcass layer than in the working layer. Moreover, given the materials that make up the respective reinforcing elements thereof, which are textile for the carcass layer and metal for the working layers, the working layers break at a much higher level of stressing than that of the carcass layer.

Furthermore, the textile carcass layer has an elongation at break around ten times greater than that of the working layers, and so the working layers are considered to be the ones to break first.

Thus, the working layers appear, according to the prior art, to be the essential element for the breaking energy performance and the carcass layer is considered to be a parameter that has only a minor influence on the performance.

A more in-depth analysis shows that bending is not the major parameter of the breaking energy performance. Breaking of the crown is due to the tensioning of the different layers beneath the tread against which the indenter will press. On account of the geometry of the tyre, since the working layers have a length, with a value close to the outer perimeter of the tyre, much greater than their width, the radius of curvature of the crown at the level of the indenter is smaller in the transverse direction than in the circumferential direction. This is verifiable by testing and by simulation. Thus, the carcass, which is oriented in the transverse direction, is stressed more than the working layers.

This aspect is also enhanced by the current tread patterns, in which the longitudinal furrows promote deformation in the transverse direction.

For a given stress, the composite making up the tyre deforms as far as an equilibrium position. The working layers shear such that the reinforcing elements thereof can effectively take up the forces applied. For inflation and loading, which are the basic stresses applied to a tyre, the equilibrium angle of the reinforcing elements of the working layers is close to 20°. The equilibrium angle of the reinforcing elements of the working layers under the deformation brought about by the breaking energy test is not obtained for an angle close to 25° but for an angle that is at least equal to 30° and can be as much as 45°. Given the respective stiffnesses of the different layers, the carcass layer will deform under tension and the working layers will deform by the shearing of the rubbers until the reinforcing elements of the working layers form an angle close to the equilibrium angle with the circumferential direction.

For a crown in which the working layers have a high linear breaking strength, greater than 400 daN/cm, the carcass layer is a secondary element for the breaking energy performance. Whether the carcass layer breaks before or after the working layers during the test, the tyre achieves the level required by the regulations by observing the safety margin of 10% mentioned above.

In the context of the invention, the working layers do not by themselves make it possible to achieve the level required by the regulations. The idea of the invention is to create a working relationship between the dimensioning of the carcass layer and that of the working layers in order to achieve this objective. Two conditions are necessary for this. The first condition is that the carcass layer can absorb the elongation when the working layers shear in order that their reinforcing elements are at the equilibrium angle for the deformation brought about by the test. The second condition is that the linear breaking strength of the carcass layer is sufficiently high compared with those of the working layers in order that the breaking energy of the carcass layer plus that of the working layers makes it possible to achieve the regulation threshold corrected by the safety margin of 10% mentioned above.

This working relationship is obtained by increasing the linear breaking strength of the carcass layer in light of the linear breaking strength necessary for the withstand of the pressure and thus by modifying the strength ratio between the strengths of the carcass layer and of the working layers. This involves increasing the mass of the carcass layer, which goes against the overall desired objective, but this increase is low compared with the saving of mass obtained via the use of monofilaments in the working layers.

It is essential that, for tyres having a nominal width at least equal to 135 mm, preferably at least equal to 185 mm and at most equal to 235 mm, the linear breaking strength Rcc of the carcass layer is at least equal to 0.55 times the linear breaking strength Rct of all the working layers, preferably at least equal to 0.6 times and at least equal to 0.65 times for tyres of which the nominal width is at least equal to 245 mm. This is because the width of the tyre influences the transverse radius of curvature applied notably to the carcass layer during the application of the indenter during the test and thus influences the stressing applied to the carcass layer. The nominal width means the width of the tyre given by dimensional designation well known to a person skilled in the art.

Thus, the linear breaking strength Rcc of the carcass layer is at least equal to 0.55 times the minimum of the linear breaking strengths of all the working layers. This allows a significant contribution of the carcass layer to the breaking energy performance.

The greater the linear breaking strength of the carcass layer, provided that the reinforcing elements of the carcass layer break at a sufficient level of elongation for the carcass layer to cooperate with the working layers to satisfy the performance level required by the regulations, the greater the addition of energy by the carcass layer and thus the more readily the tyre will comply with the level of performance required by the regulations. The designer may choose between several types of reinforcing elements that satisfy these characteristics depending on their materials, the diameter of the reinforcing elements of the carcass layer, their costs, the ease of supply, among other possible choice criteria.

A preferred solution is for the carcass layer to have a linear breaking strength Rcc at least equal to 190 daN/cm, preferably equal to 200 daN/cm, and even more advantageously at least equal to 220 daN/cm.

Advantageously, the elongation at break Acc of the reinforcing elements of the carcass layer is at least equal to 15%, preferably equal to 20%, and even more advantageously at least equal to 25%.

The necessary level of elongation at break of the reinforcing elements of the carcass layer for allowing effective cooperation of the working layers and the carcass layer depends, among other parameters, on the shear moduli of the rubber materials surrounding the reinforcing elements of the working layers and the angles that the reinforcing elements of the working layers make with the circumferential direction in the new state of the tyre. Depending on the value of these parameters, the tyre designer may choose the most appropriate material for satisfying the performance level required by the regulations depending on the elongation at break Acc of the reinforcing elements of the carcass layer that is necessary.

Advantageously, the textile reinforcing elements of the carcass layer are made of polyethylene terephthalate, notably high-tenacity polyethylene terephthalate, rayon, a combination of aliphatic polyamide and aromatic polyamide, or a combination of polyethylene terephthalate and aromatic polyamide, each of these materials having different advantages in this context of breaking strength and elongation at break, among other criteria.

As far as the reinforcing elements are concerned, the breaking strength and elongation at break measurements are carried out under tension using well-known procedures, for example according to the standard ISO 6892 of 1984 for steel reinforcing elements.

Under the objective of reducing the mass of the tyre, an optimum is achieved when the reinforcing elements of the working layers are individual metal threads or monofilaments. The monofilaments make it possible to obtain a working layer with a smaller radial thickness than with a cord. This makes it possible to reduce the volume of rubber compound around the cords. For the type of application targeted, the monofilaments have a section of which the smallest dimension is at most equal to 0.40 mm, preferably at most equal to 0.35 mm. Furthermore, monofilaments of which the smallest dimension is greater than 0.40 mm would cause problems in terms of deformability and endurance.

It is advantageous for each working layer to comprise metal reinforcing elements that form, with a circumferential direction (XX′) of the tyre, an angle (A1, A2) at least equal to 20° and at most equal to 45°, preferably at least equal to 23° and at most equal to 35°. These angles allow optimal functioning of the tyre as regards performance in terms of crown endurance, behaviour and rolling resistance.

The reinforcing elements of the working layers may or may not be rectilinear. They may be preformed, with a sinusoidal, zigzag, or wavy shape, or a shape following a spiral. The metal reinforcing elements of the working layers are made of steel, preferably carbon steel such as those used in cords of the “steel cords” type, although it is of course possible to use other steels, for example stainless steels, or other alloys.

When a carbon steel is used, its carbon content (% by weight of steel) is preferably in a range from 0.8% to 1.2%. The invention is particularly applicable to steels of the very high strength “SHT” (“Super High Tensile”), ultra-high strength “UHT” (“Ultra High Tensile”) or “MT” (“Mega Tensile”) steel cord type. The carbon steel reinforcers then have a tensile breaking strength (Rm) which is preferably higher than 3000 MPa, more preferably higher than 3500 MPa. Their total elongation at break (At), which is the sum of the elastic elongation and the plastic elongation, is preferably greater than 1.6%.

The steel used, whether it is in particular a carbon steel or a stainless steel, may itself be coated with a layer of metal, which improves for example the workability of the steel monofilament or the wear properties of the reinforcer and/or of the tyre themselves, such as properties of adhesion, corrosion resistance, or resistance to ageing. According to one preferred embodiment, the steel used is covered with a layer of brass (Zn—Cu alloy) or of zinc; it will be recalled that, during the process of manufacturing the threads, the brass or zinc coating makes the thread easier to draw, and makes the thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

The monofilaments may have any cross-sectional shape, in the knowledge that oblong cross sections represent an advantage over circular cross sections, even when of smaller size. A working layer made up of correctly arranged monofilaments with oblong cross sections may, for the same breaking strength, have a smaller thickness than a working layer in which the reinforcing elements have circular cross sections. Furthermore, the bending inertia of monofilaments with oblong cross sections is greater than the bending inertia of monofilaments with circular cross sections and so their resistance to buckling is greater, resistance to buckling being an important criterion for dimensioning the monofilaments. In the case of a circular cross section, the smallest dimension corresponds to the diameter of the cross section. In order to guarantee a fatigue breaking strength of the monofilaments and the resistance to shearing of the rubber compounds situated between the monofilaments, the density of metal reinforcing elements of each working layer is at least equal to 100 monofilaments per dm and at most equal to 200 monofilaments per dm, preferably at least equal to 115 monofilaments per dm and at most equal to 170 monofilaments per dm. What is meant by the density is the mean number of monofilaments over a 10-cm width of the working layer, this width being measured perpendicularly to the direction of the monofilaments in the working layer in question. The distance between consecutive reinforcing elements may be fixed or variable. For the different calculations of linear breaking strength of a layer, the density is expressed in suitable units, in reinforcing elements per cm for example, in order to ensure the consistency of the calculations.

The reinforcing elements may be laid during manufacture either in layers, in strips, or individually.

A preferred solution is that the density of textile reinforcing elements in the carcass layer, measured in the vicinity of the radially outermost point of the carcass layer, is at least equal to 40 reinforcing elements per dm and preferably at least equal to 50 reinforcing elements per dm. Since the performance in the breaking energy test is linked to the density of reinforcing elements in the carcass layer in the part radially beneath the working layers, the density of reinforcing elements in the carcass layer is measured in this part of the carcass layer and not at the beads, as it is possible to do for some applications. The invention is linked to the performance of the crown in terms of mass, rolling resistance and the breaking energy test. Therefore, the density of the reinforcing elements of the carcass layer is likewise measured at the crown in a similar manner to for the working layers.

Preferably, the textile reinforcing elements of the carcass layer are made up of spun elementary filaments subjected to torsion, and the torsion in the constituent spun elementary filaments of the textile reinforcing elements of the carcass layer is at least equal to 185 t/m and at most equal to 420 t/m.

It will be recalled here simply that these textile cords or folded yarns, traditionally with a double twist (Ti, T2), are prepared by a twisting method in which:
during a first step, each constituent spun yarn or multifilament fibre (or just “yarn”) of the final cord is first of all twisted individually on itself (with an initial twist Ti) in a given direction DI (respectively in the S or Z direction) in order to form a strand in which the elementary filaments find themselves deformed into a helix around the axis of the fibre (or axis of the strand);
next, during a second step, a plurality of strands, generally, two, three or four thereof, of identical or different types in the case of cords known as hybrid or composite cords, are then twisted together with a final twist T2 (which may be the same as or different from Ti) in the opposite direction D2 (respectively in the Z or S direction, using recognized terminology denoting the orientation of the turns according to the transverse bar of an S or of a Z), in order to obtain the cord or final assembly having a plurality of strands.

The purpose of the twisting is to adapt the properties of the material so as to create the transverse cohesion of the reinforcer, increase its fatigue resistance and also improve adhesion with the reinforced matrix. Such textile cords, their constructions and methods of manufacture are well known to a person skilled in the art. They are described in detail in a large number of documents, to cite only a few examples in the patent documents EP 021 485, EP 220 642, EP225 391, EP 335 588, EP 467 585, U.S. Pat. Nos. 3,419,060, 3,977,172, 4,155,394, 5,558,144, WO97/06294 or EP 848 767, or more recently WO2012/104279, WO2012/146612, WO2014/057082.

In order to be able to reinforce rubber articles such as tyres, the fatigue strength (endurance in tension, bending, compression) of these textile cords is of key importance. It is known that, in general, for a given material, the greater the twist used, the greater said fatigue strength is, but that, on the other hand, the breaking strength in tension (referred to as tenacity when expressed per unit weight) thereof decreases inexorably as the twist increases, something which is, of course, detrimental from the point of view of reinforcement and the breaking energy performance. Hence, the designers of textile cords, like tyre manufacturers, are constantly looking for textile cords of which the mechanical properties, particularly the breaking force and tenacity, for a given material and a given twist, may be improved. It is this balance that is sought here in order to satisfy all of the performance aspects of the tyre, including the breaking energy performance.

It is advantageous for the crown reinforcement to comprise at least one hooping layer and for the hooping layer to be radially on the outside of the working reinforcement in order to ensure good endurance of the latter. The hooping layer comprises reinforcing elements that make an angle at most equal to 8° with the circumferential direction.

Preferably, the reinforcing elements of the at least one hooping layer are made of textile, preferably of the aliphatic polyamide, aromatic polyamide, combination of aliphatic polyamide and of aromatic polyamide, polyethylene terephthalate or rayon type, because textile materials are particularly well suited to this type of use on account of their low mass and high stiffness. The distance between consecutive reinforcing elements in the hooping layer, or spacing, may be fixed or variable. The reinforcing elements may be laid during manufacture either in layers, in strips, or individually.

### DESCRIPTION OF THE DRAWINGS

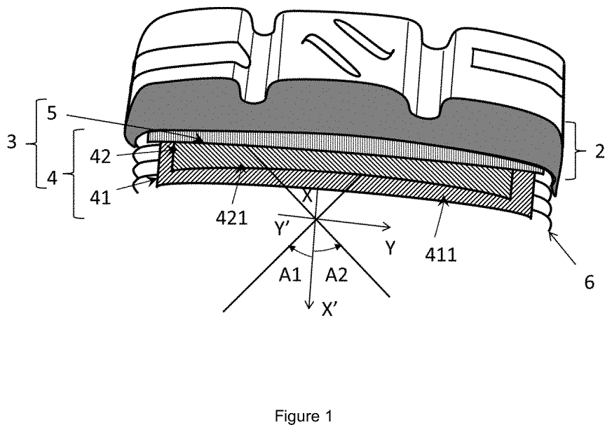

The features and other advantages of the invention will be understood better with the aid of FIG. 1, which shows a meridional cross section of the crown of a tyre according to the invention.

The tyre has a tread 2 intended to come into contact with the ground via a tread surface 21. The tyre also comprises a crown reinforcement 3 radially on the inside of the tread 2 and comprising a working reinforcement 4 and a hoop reinforcement 5. The working reinforcement comprises two working layers 41 and 42 each comprising mutually parallel reinforcing elements 411, 412 that respectively form, with a circumferential direction (XX′) of the tyre, an oriented angle A1, A2 at least equal to 20° and at most equal to 50°, in terms of absolute value, and of opposite sign from one layer to the next. The tyre likewise comprises a single carcass layer 6 radially on the inside of the crown reinforcement.

The inventors carried out calculations on the basis of the invention for a tyre of size 225/55 R16, with a nominal width of 225 mm, comprising two working layers and one carcass layer.

The control tyre TA of conventional non-inventive design comprises:
two working layers comprising reinforcing elements made up of cords of two threads with a diameter of 0.3 mm at a density of 95 reinforcing elements per decimetre for a linear breaking strength Rct equal to 420 daN/cm,
a carcass layer made of polyethylene terephthalate comprising two strands of 220 tex at a density of 63 reinforcing elements per dm for a linear breaking strength of 180 daN/cm, the reinforcing elements having an elongation at break of 19%. The ratio of the linear breaking strengths of the carcass layer and the working layers is equal to 0.43.

This design makes it possible to have a sufficient performance in the breaking energy test of more than 680 J as opposed to an admissible limit of 588 J according to the standard.

The need for savings in mass and improvements in rolling resistance has led the inventors to the use of working layers comprising steel monofilaments.

In line with the prior art, a tyre TA2 was designed by the inventors in which the carcass layer remains unchanged. The saving in mass for this design is thus 200 g and the improvement in rolling resistance is close to 0.15 kg/t. This non-inventive tyre comprises:
two working layers comprising reinforcing elements made up of HT (High Tensile) steel monofilaments with a diameter of 0.32 mm, distributed at a density of 143 monofilaments per decimetre for a linear breaking strength Rct equal to 350 daN/cm, and the ratio of the linear breaking strengths of the carcass layer and of the working layer is then equal to 0.51.

However, this tyre TA2 exhibits an unsatisfactory performance in the breaking energy test of 610 j, i.e. barely 3% above the regulation value, this considerably limiting the number of markets on which it could be sold.

The invention consists in modifying the reinforcing elements of the carcass layer to design the tyre A. The tyre A, according to the invention, comprises:
two working layers, identical to those of TA2 since they are innovative, allowing the saving in mass and improvement in rolling resistance, comprising reinforcing elements made up of HT (High Tensile) steel monofilaments with a diameter of 0.32 mm, distributed at a density of 143 monofilaments per decimetre for a linear breaking strength Rct equal to 350 daN/cm,
a carcass layer made of polyethylene terephthalate comprising two strands of 344 tex at a density of 53 reinforcing elements per dm for a linear breaking strength of 214 daN/cm, the reinforcing elements having an elongation at break of 19%, and the ratio of the linear breaking strengths of the carcass layer and of the working layer is then equal to 0.61.

The saving in mass for this design is then 200 g and the improvement in rolling resistance is close to 0.15 kg/t compared with the initial tyre TA, and its breaking energy performance is 960 J, i.e. greater than the value set by the regulations.

For all of the tyres described, the angles A1 and A2 of the reinforcing elements of the working layers are respectively equal to +25° and −25°.

The inventors carried out a second set of tests on the basis of the invention for a tyre of size 255/55 R18, with a nominal width of 255 mm, comprising two working layers and one carcass layer.

The control tyre TB of conventional non-inventive design comprises:
two working layers comprising reinforcing elements made up of cords of four threads with a diameter of 0.26 mm at a density of 80 reinforcing elements per decimetre for a linear breaking strength Rct equal to 480 daN/cm,
a carcass layer made of polyethylene terephthalate comprising two strands of 334 tex at a density of 52 reinforcing elements per dm for a linear breaking strength of 212 daN/cm, the reinforcing elements having an elongation at break of 19%. The ratio of the linear breaking strengths of the carcass layer and the working layer is then equal to 0.44.

This design makes it possible to have a sufficient performance in the breaking energy test of more than 790 J as opposed to an admissible limit of 588 J according to the regulations.

The need for savings in mass and improvements in rolling resistance has led the inventors to the use of working layers comprising steel monofilaments.

In line with the prior art, a tyre TB2 was designed by the inventors in which the carcass layer remains unchanged. The saving in mass for this design is thus 650 g and the improvement in rolling resistance is close to 0.15 kg/t. This non-inventive tyre comprises:
two working layers comprising reinforcing elements made up of HT (High Tensile) steel monofilaments with a diameter of 0.32 mm, distributed at a density of 143 monofilaments per decimetre for a linear breaking strength Rct equal to 350 daN/cm. The ratio of the linear breaking strengths of the carcass layer and the working layer is then equal to 0.605.

However, this tyre TB2 exhibits an unsatisfactory performance in the breaking energy test of 500 j, i.e. below the regulation value, this considerably limiting the number of markets on which it could be sold.

The invention consists in modifying the reinforcing elements of the carcass layer to design the tyre B. The tyre B, according to the invention, comprises:
two working layers comprising reinforcing elements made up of HT (High Tensile) steel monofilaments with a diameter of 0.32 mm, distributed at a density of 143 monofilaments per decimetre for a linear breaking strength Rct equal to 350 daN/cm,
a carcass layer made of nylon comprising three strands of 210 tex at a density of 52 reinforcing elements per dm for a linear breaking strength of 234 daN/cm, the reinforcing elements having an elongation at break of 27%. The ratio of the linear breaking strengths of the carcass layer and the working layer is then equal to 0.67.

The saving in mass for this design is then 650 g and the improvement in rolling resistance is close to 0.15 kg/t compared with the initial tyre TB, and its breaking energy performance is 937 J, i.e. much greater than the value set by the regulations.

For all of the tyres described, the angles A1 and A2 of the reinforcing elements of the working layers are respectively equal to +25° and −25°.

1.-12. (canceled)

13. A tire for a vehicle comprising:
a tread;
a crown reinforcement radially on the inside of the tread and comprising at least one working reinforcement, the at least one working reinforcement comprising at least two working layers, each working layer comprising metal reinforcing elements, the metal reinforcing elements of the working layers comprising individual metal threads or monofilaments, and each working layer having a linear breaking strength Rct defined by Rct=Fr*d, where Fr is the tensile breaking force of the metal reinforcing elements, and d is the density of the metal reinforcing elements, measured around the radially outermost point of each working layer; and
a single carcass layer that is radially on the inside of the crown reinforcement and connects together two beads that are intended to come into contact with a rim and comprise textile reinforcing elements, the single carcass layer having a linear breaking strength Rcc defined by Rcc=Fr*d, where Fr is the tensile breaking force of the textile reinforcing elements, and d is the density of the textile reinforcing elements, measured around the radially outermost point of the single carcass layer,
wherein the linear breaking strength Rct of each working layer is at least equal to 300 daN/cm and at most equal to 400 daN/cm,
wherein elongation at break Acc of the textile reinforcing elements of the single carcass layer is at least equal to 15%, and
wherein, when the tire has a nominal width at least equal to 135 mm, the linear breaking strength Rcc of the single carcass layer is at least equal to 0.55 times the linear breaking strength Rct of the at least two working layers, and, when the tire has a nominal width at least equal to 245 mm, the linear breaking strength Rcc of the single carcass layer is at least equal to 0.65 times the linear breaking strength Rct of the at least two working layers.

14. The tire according to claim 13, wherein the single carcass layer has a linear breaking strength Rcc at least equal to 190 daN/cm.

15. The tire according to claim 13, wherein the textile reinforcing elements of the single carcass layer have an elongation at break Acc at least equal to 20%.

16. The tire according to claim 13, wherein the textile reinforcing elements of the single carcass layer are made of spun elementary filaments subjected to torsion, and wherein the torsion in the spun elementary filaments is at least equal to 185 t/m and at most equal to 420 t/m.

17. The tire according to claim 13, wherein the textile reinforcing elements of the single carcass layer are made of polyethylene terephthalate, rayon, a combination of aliphatic polyamide and aromatic polyamide, or a combination of polyethylene terephthalate and aromatic polyamide.

18. The tire according to claim 13, wherein the metal reinforcing elements of at least one working layer are made of individual metal threads or monofilaments having a section of which the smallest dimension is at most equal to 0.40 mm.

19. The tire according to claim 13, wherein each working layer comprises metal reinforcing elements that form, with a circumferential direction of the tire, an angle at least equal to 20° and at most equal to 45°.

20. The tire according to claim 13, wherein each working layer comprises metal reinforcing elements that form, with a circumferential direction of the tire, an angle at least equal to 23° and at most equal to 35°.

21. The tire according to claim 13, wherein the metal reinforcing elements of the working layers are made of carbon steel.

22. The tire according to claim 13, wherein the density of metal reinforcing elements in a single working layer is at least equal to 100 monofilaments per dm and at most equal to 200 monofilaments per dm.

23. The tire according to claim 13, wherein the density of the textile reinforcing elements in the single carcass layer, measured in the vicinity of the radially outermost point of the carcass layer, is at least equal to 40 reinforcing elements per dm and preferably at least equal to 50 reinforcing elements per dm.

24. The tire according to claim 13, further comprising at least one hooping layer, wherein reinforcing elements in the at least one hooping layer are made of textile.

25. The tire according to claim 24, wherein the textile is selected from the group consisting of polyethylene terephthalate, aliphatic polyamide, combination of aliphatic polyamide and aromatic polyamide, and combination of polyethylene terephthalate and aromatic polyamide type.
